(19) United States
(12) Patent Application Publication
(10) Pub. No.: US 2006/0064489 A1
(43) Pub. Date: Mar. 23, 2006

(54) Method for limiting the number of network devices in a communication network

(76) Inventor: Laszlo Hars, Township, PA (US)

Correspondence Address: PHILIPS INTELLECTUAL PROPERTY & STANDARDS, P.O. BOX 3001, BRIARCLIFF MANOR, NY, 10510, US

(21) Appl. No.: 10/537,130

(22) PCT Filed: Nov. 28, 2003
(86) PCT No.: PCT/IB03/05506

§ 371 Date: Jun. 2, 2005

(30) Foreign Application Priority Data
Dec. 4, 2002 (US) 60430877

(51) Int. Cl. G06F 15/173

(52) U.S. Cl. 709/226

(57) ABSTRACT

A network of M devices such that M³1 and methods for devices to join and leave the network. Each device of the network has a real or virtual token counter that stores a token count of not less than zero. An equation M+S &equals; K must be satisfied. S denotes the number of tokens in the network and is numerically equal to a summation of the token counts over the M devices. K is a characteristic integer constant of the network having a value of at least 2 and is established upon creation of the network. Each device has a controller for connecting and communicating with at least one other device when M>1. The network has network rules, comprising a joining rule for effectuating a non-network device joining the network and a leaving rule for effectuating a network device leaving the network.

The present invention relates to a network of compliant devices and a method for limiting the size of the network.

A network of devices may share content among the devices. However, the content owner may desire to have controls in place to limit access to the shared content Hence, the network should be structured so as to limit access to the shared content.

The present invention provides a network, comprising:

M devices such that M³1, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network;

network rules, comprising a joining rule for effectuating a non-network device DJ joining the network and a leaving rule for effectuating a device DL of the M devices leaving the network; and

the network not including a server device for managing the number of devices in the network.

The present invention provides a method of joining a non-network device DJ to a network of devices, comprising:

providing the network as comprising M devices such that M³1, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network method by which a device DL leaves a network, comprising:

providing the network as comprising M devices such that M³1, device DL being one of the M devices, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network, and wherein the network does not include a server device for managing the number of devices in the network, and

attempting to join the device DJ to the network in accordance with a joining rule.

The present invention provides a method by which a device DL leaves a network, comprising:

providing the network as comprising M devices such that M³1, device DL being one of the M devices, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network, and wherein the network does not include a server device for managing the number of devices in the network; and

attempting by the device DL to leave the network in accordance with a leaving rule.

The present invention provides a network of devices having shared content, subject to rules that limit the number of devices in the network so as to limit access to the content shared.

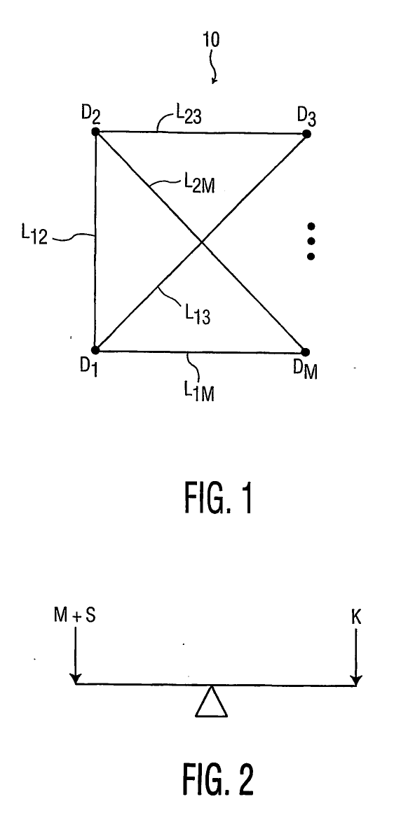

FIG. 1 illustrates a network of devices, in accordance with embodiments of the present invention.

FIG. 2 illustrates the invariance of the sum of devices and tokens, in accordance with embodiments of the present invention.

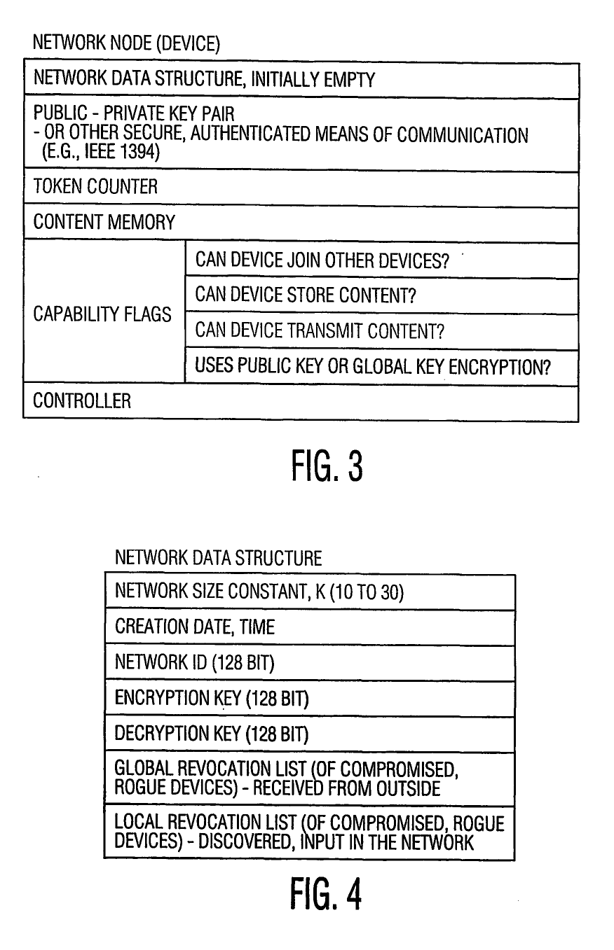

FIG. 3 illustrates the structure of a network node, in accordance with embodiments of the present invention.

FIG. 4 illustrates a network data structure, in accordance with embodiments of the present invention.

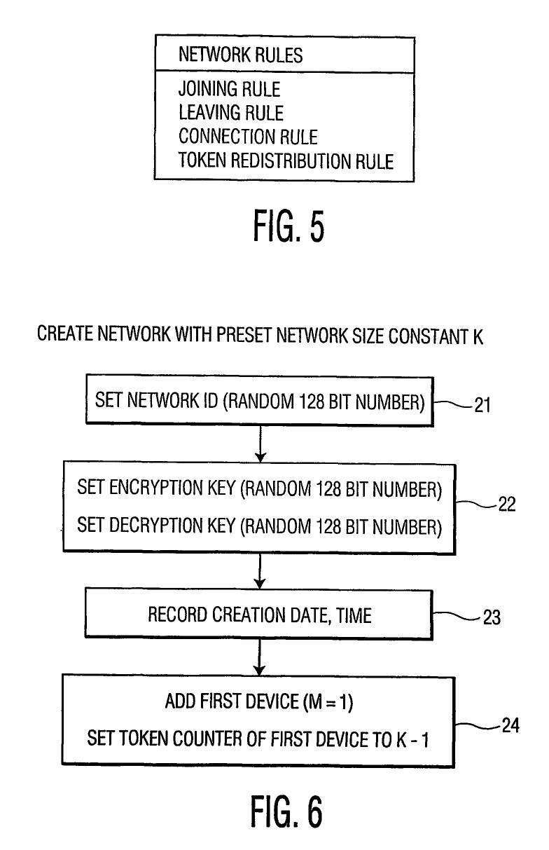

FIG. 5 is a list of network rules, in accordance with embodiments of the present invention.

FIG. 6 illustrates creation of a network, in accordance with embodiments of the present invention.

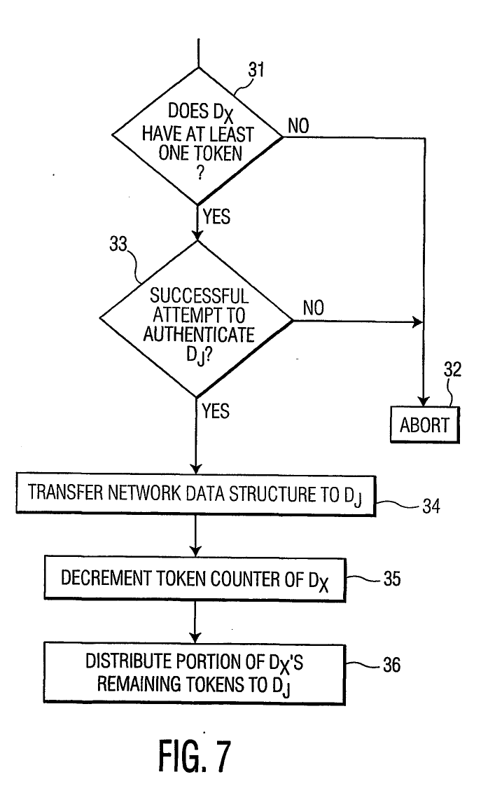

FIG. 7 illustrates a network's joining protocol from the perspective of a network member device, in accordance with embodiments of the present invention.

FIG. 8 illustrates a network's joining protocol from the perspective of a joining member device, in accordance with embodiments of the present invention.

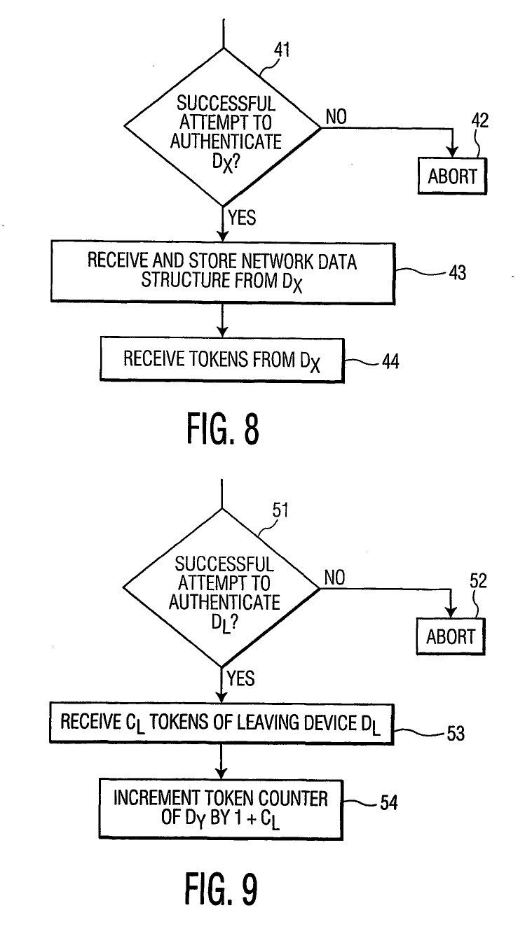

FIG. 9 illustrates a network's leaving protocol from the perspective of a non-leaving network member device, in accordance with embodiments of the present invention.

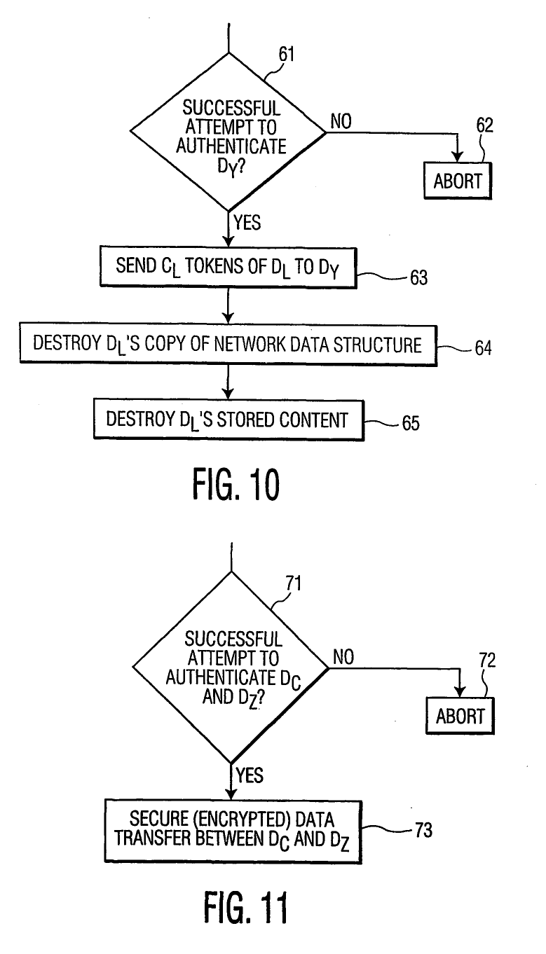

FIG. 10 illustrates a network's leaving protocol from the perspective of a leaving member device, in accordance with embodiments of the present invention.

FIG. 11 illustrates connection protocol, in accordance with embodiments of the present invention.

A network such as, inter alia, a home network may include consumer electronic (CE) devices (e.g., a television (TV), video cassette recorder (VCR), compact disk (CD) player, etc.). Such a network starts with only one node, namely a first device such as a newly purchased CE device. The network has an identifier (ID) which is a unique set of characters that differentiates it from other networks. Data (e.g., multimedia content) can be shared among devices within the network, but not with outsiders. To ensure data security, stored content is encrypted, either at the time of storage or at the time of a transfer of the content to another device. When a second device is acquired, it may be joined to the existing network of devices in order to be able to share stored electronic content with devices on the existing network. This enhances capabilities of the network, such as being able to see a recorded TV show in the kitchen or in the family room without physically moving equipment or media (e.g., tape, disk, etc.).

If the network could be substantially extended with the addition of many new devices, then neighbors, friends, family members, etc. could join to this network and one copy of a copyrighted content would be viewable by more people than is acceptable to the copyright owner or licensee. Therefore, there may be a need to limit the size (i.e., the number of devices) of the network. As an example, there may be a need to limit the number of devices on the network to 10 devices. Thus, there is also a need to track of the size of the network as more devices are added to the network. One possibility is to employ a “server device”, namely a special member device of the network which stores the number of member devices. Each device join has to be approved by the server device. A draw-back of this solution is that the server device has to be always on-line and connected. A possible scenario is that a person takes a portable MP3 player to his or her car and connects the MP3 player to the car stereo system. If the person wants the MP3 player to share content with other devices on the network, then the MP3 player has to join the network. However, the car stereo may not be connected to the server device at the intended time of joining, so that the join of the MP3 player cannot take place when intended, even if there are fewer devices joined to the network than the maximum number devices allowed in the network. The present invention uses a token system instead of a server device for managing the number of devices in the network. An existing network device can join other devices to the network, even if the existing network device is not connected at that time to the network. This is accomplished by use of tokens which are counted on a token counter in each device of the network. A token is a number on a token counter and is thus a virtual token rather than a physical token. If a given device “receives” T tokens, then the token counter of the given device is incremented by T. If the given device transfers or “gives away” U tokens, then the token counter of the given device is decremented by U. A member device of the network may receive tokens from other devices when the member device needs the tokens

When another device wants to join the network, a physical connection (e.g., radio, infrared, ultrasound, wired, plugged in, etc.) is established between the joining device and an existing member device that has at least one token (i.e., the existing member device's token counter has a token count of at least 1). Both the joining device and the existing member device check each other's authenticity, which includes verifying that both devices are compliant with each other. If the authenticity checks are successful, then the existing member device transfers all information (e.g., encryption keys, network ID's, etc.) to the joining device that is necessary for the joining device to be a member of the network The existing member device decrements its token counter by 1 and may share additional of its tokens with the joining device. The joining device can subsequently join a new device to the network if the joining device has at least one token to use to join the new device to the network.

When a device leaves the home network, the leaving device gives its tokens, if any, to another existing network device to which the leaving device is connected to at the time of the leave. The another existing device ensures that the leaving device destroys all of the leaving device's stored content, stored copy of the network ID, and stored copy of cryptographic keys of the network. At this leaving time, the another existing device increments its number of tokens by 1, reflecting the fact that the network shrank by one device upon the exit of the leaving device.

When a device breaks, gets compromised, gets lost, etc., said device may be expelled from the network, which results in rebuilding the network, including transferring and re-encrypting all of the stored content in the network. This transferring and re-encrypting can be done in a delayed manner, whenever a physical connection is established between a device and the rebuilt network.

Based on the preceding discussion, the present invention discloses a network of devices such as, inter alia, a home network of devices. The network is limited to a maximum of K devices, wherein K is positive integer of at least 2. A device of the network is a hardware device such as a consumer electronics device (e.g., a television, VCR, computer, CD player, etc.). Each device of the network is capable of being connected to at least one other device of the network, and some of the devices are able to share information or content with each other. The sharing of information or content between devices involves a transfer of information or content between devices, and the information or content which is so transferred may be encrypted. Thus the sender of the information or content may need an encryption key and the receiver of the information or content may need a decryption key. The scope of the present invention also includes the case in which data transfer is not encrypted. The imposition of the limit K on the maximum number of such devices in the network restricts the freedom of the owner of the devices, but protects the owner or licensee of the shared information or content on the devices. The constant K is referred to herein as a network size constant.

There are M devices in the network at any time, wherein 1£M£K. Whenever M<K it is possible for up to K−M new devices to join the network. Thus there are K−M membership vacancies which may be subsequently filled by new members. The network includes “tokens” to represent the membership vacancies. Defining S=K−M, there are S tokens in the network whenever M<K. When M=K, there are no tokens in the network since S=0 when M=K. The S tokens are distributed among the M devices. Thus each device of the M devices may hold one or more tokens such that the sum of the tokens held by the M devices collectively is S. The equation M+S=K expresses the invariance of M+S and is a fundamental equation of the network. The significance of a member device holding a token is that a requirement for a non-member device to become a member device of the network is that the non-member device must connect to one member device of the M devices and engage in a joining protocol with this one member device. If the joining protocol is successful, then this one member device destroys a token that the one member device holds in order to preserve the invariance of M+S; i.e., the joining of the non-member device to the network increments M by 1 so that S must be decremented by 1 to satisfy the fundamental equation of the network. Thus, if this one member device does not hold any tokens, then the non-member device cannot join the network by connecting to this one member device but may instead connect to another member device that holds at least one token.

Similarly, a member device leaving that network must be connected to a non-leaving member device and engage with the non-leaving member device in a leaving protocol. If the leaving protocol is successful, then this non-leaving member device acquires an extra token so as to increment S by 1, which compensates for M being decremented by 1 as a result of the member device leaving the network. If all member devices leave the network, then M=0 which is not allowed and the network is destroyed. A network device may leave the network for any reason such as, inter alia, the network owner may desire to sell or discard the leaving device, or the network is filled up with devices (i.e., S=0 and M=K) and the network owner desires to make room for another device to join the network.

Each device has a token counter that contains the number of tokens held by the device. The token counter is incremented and decremented as tokens are added to the device and subtracted from the device, respectively. A real token counter may be a memory slot in the device. Some devices do not ever hold tokens and do not have a real token counter. Such a device that never holds tokens is considered to have a virtual token counter that always holds a value of zero. Thus each device of the M devices has a real or virtual token counter that stores a token count of not less than zero. A consequence of a particular device having a virtual token counter is that the particular device would not need an encryption key for joining other devices to the network.

Protocols between or among participating devices (e.g., a joining protocol or a leaving protocol) typically require authentication by each participating device. An authentication made by a first participating device may include, inter alia, checking a second participating device's ID and/or associated password. The authentication may also include, inter alia, a determination of whether the second participating device is physically and logically compatible with the first participating device.

FIG. 1 illustrates a network 10 of M devices denoted as D1, D2, . . . , DM wherein M³1, in accordance with embodiments of the present invention. L12 is a potential communication link between devices D1 and D2. L23 is a potential communication link between devices D2 and D3. L1M is a potential communication link between devices D1 and DM. L2M is a potential communication link between devices D2 and DM. The aforementioned potential links may each represent a real communication link or not represent a real communication link, since a given device may have the capability of being connected to some devices but not to other devices. A real communication link may be through wires, wireless, through telephone lines, through cable lines, through an Ethernet, through the Internet, etc. The network 10 does not comprise a server device for managing the number of devices in the network.

FIG. 2 illustrates the invariance of the sum of devices and tokens, in accordance with embodiments of the present invention. FIG. 2 shows that M+S is balanced against K and thus represent the fundamental network equation of M+S=K.

FIG. 3 illustrates the structure of a network node, in accordance with embodiments of the present invention. A network node holds a member device and the node may be thought of as the member device itself. The network node includes node information and hardware that is unique to the node. The network node comprises: a network data structure, a public-private key pair, a token counter, content memory, capability flags, and a controller. The network data structure, which is described infra in conjunction with FIG. 4, comprises network information that is not unique to any device of the M devices. The public-private key pair or other secure, authenticated means of communication (e.g., IEEE 1394) supports encrypted data transfer between devices. The token counter is for keeping track of tokens held by the device as explained supra. As explained supra, not all devices require a real token counter, and some devices may have a virtual token counter. Content memory is for storing content such as video content, audio content (e.g., music), text content, etc. Not all devices need to store content and thus not all devices include content memory. For example, a television may not have content memory.

The capability flags in FIG. 3 each include a value that denotes whether the device has the indicated capability. Although FIG. 3 depicts four example capability flags, the scope of the present invention may not include all of the four example capability flags and may include other capability flags not shown in FIG. 3. For the capability flag “Can device join other devices?”, a value of YES implies that the device requires a real token counter, but a value of NO implies that the device does not require a real token counter and may instead have a virtual token counter. For the capability flag “Can device store content?”, a value of YES implies that the device must destroy its stored content when leaving the network. For the capability flag “Can device transmit content?”, a value of YES implies that the device has the capability of encrypting information if encryption is required in the network. For the capability flag “Uses public key or global key encryption?” an intelligent device such as a computer may use public key encryption while a relatively dumb device such as a Cd player may use global key encryption. Some devices may not use any encryption. FIG. 3 also indicates a controller in the network node. Each device has a controller which handles communication with other devices. The controller. 3 may also perform other functions such as incrementing or decrementing the token counter, processing protocols which depend on values of capability flags, transfer data or content, encrypt and decrypt data, etc.

FIG. 4 illustrates a network data structure, in accordance with embodiments of the present invention. The network data structure comprises network information that is not unique to any device of the M devices. The network data structure in FIG. 4 includes: the network size constant K, the network creation date and time, the network identifier (ID), the network encryption key, the network decryption key, a global revocation list, and a local revocation list. The network size constant K satisfies K³2 generally and representative values of K range from 10 to 30. The network ID may be contained within, inter alia, a 128 bit word. The encryption key may be contained within, inter alia, a 128 bit word. The decryption key may be contained within, inter alia, a 128 bit word. In some networks, all devices having encryption and decryption keys have the same encryption and decryption keys, while in other networks some or all devices have keys which are unique for each device. A revocation list is a list of non-network devices which are not to be joined to the network for any of several reasons. As an example, a rogue device may be known to have been hacked such that the rogue device is susceptible to having its content and data stolen. Such a rogue device would be a security risk to the network and should not be joined to the network. The devices listed in a global revocation list are identified from a source that is out of the network (e.g., a newsletter announcement of an outside organization). The devices listed in a local revocation list are identified from a source that is within the network (e.g., a network device has the identification of the rogue device encoded within itself). The distinction between a global revocation list and a local revocation list may be neglected for some networks so that only one revocation list is present. Other networks do not have any revocation list. The local revocation list is unique to the particular network, while the global revocation list may be shared among a plurality of networks.

The network functions in accordance with network rules and examples of types of network rules (a joining rule, a leaving rule, a connection rule, and a token redistribution rule) are listed in FIG. 5, in accordance with embodiments of the present invention. The network may have other network rules than those listed in FIG. 5. The entire collection of network rules constitutes the Network Policy.

An example of a joining rule is as follows. Consider a device DJ attempting to be joined to the network. DJ is required to be connected to a device DX of the M devices, and while DJ is connected the device DX a joining protocol (see FIGS. 7 and 8) must be executed by which DX authenticates DJ (including verifying that DJ is compliant with DX) and by which DJ authenticates DX and (including verifying that DX is compliant with DJ). If each of said authentications are established through said joining protocol, then DJ is joined to the network. Then the joining protocol adjusts the token counts of the M devices such that S is decremented by 1. The number of devices M of the network becomes is incremented by 1 such that the network equation of M+S=K is satisfied upon the joining of DJ to the network. If each of said authentications and verifications are not established, then DJ is not joined to the network through the connection between DJ and DX.

An example of a leaving rule is as follows. Consider a network device DL attempting to leave the network. DL is required to be connected to a device DY of the M devices, and while DL is connected the device DY a leaving protocol (see FIGS. 9 and 10) must be executed by which DY authenticates DL (including verifying that DL is compliant with DY) and by which DL authenticates DY (including verifying that DY is compliant with DL). If each of said authentications are established through said leaving protocol, then DL is deleted from the network and the leaving protocol adjusts the token counts of the remaining M−1 devices such that S is incremented by 1+CL wherein CL is the token count of DL, and the number of devices M of the network is decremented by 1 such the network equation of M+S=K is satisfied upon the leaving of DL from the network. If each of said authentications and verifications are not established, then DL is not permitted to leave the network through the connection between DL and DY.

An example of a connection rule is as follows. Consider a network device DC attempting to connect to the network. Connecting to the network means connecting to at least one device of the network. DC is required to be connected to a device DZ of the M devices, and while DC is connected the device DZ a connection protocol (see FIG. 11) must be executed by which DZ authenticates DC (including verifying that DC is compliant with DZ) and by which DC authenticates DZ (including verifying that DZ is compliant with DC.). If each of said authentications and verifications are established through said connecting protocol, then DC is permitted to connect to the network and likewise permitted to transfer data to and from DZ and to and from other devices directly and indirectly connected to DZ. Such data transfer may be encrypted. If each of said authentications and verifications are not established, then DC is not permitted to be connected to the network through the connection between DC and DZ.

A token redistribution rule redistributes the S tokens among the M devices on occasions other than when a device joins or leaves the network. Such an redistribution is called a special redistribution. A special redistribution is triggered by a condition. The token redistribution rule further prescribes an algorithm for effectuating said redistribution. The algorithm takes into account the condition that triggered the redistribution. For example, a triggering condition may be that all tokens are held by only one member device wherein more than one device exists in the network (i.e., M>1). Such a condition may be undesirable, and thus triggering, if the network philosophy is to distribute tokens as uniformly as possible among the member devices. Thus the token redistribution rule in this example may be to redistribute the tokens among the M devices as uniformly as possible. Note that not all M devices may be connected to the network while a redistribution takes place. Thus if M′ devices (2£M′<M) are connected to the network while a redistribution is taking place, then the token redistribution rule may have only the M′ devices partake in the redistribution. An alternate token redistribution rule may have all M devices partake in the redistribution by having the M′ devices immediately partake in the redistribution and have the remaining M−M′ devices partake in the redistribution at a later time when said remaining M−M′ devices are connected to the network. The M′ devices connected to the network during implementation of a token redistribution must each authenticate and verify the compliance of the other M′−1 members.

FIG. 6 illustrates creation of a network via steps 21-24, in accordance with embodiments of the present invention. The network size constant K is preset Step 21 sets the network ID, which may be, inter alia, a random 128 bit number. Step 22 sets the encryption key and decryption key, each of which may be, inter alia, a random 128 bit number. Step 23 records the date and time at which the network is created. The network requires a first device to be initiated and step 24 adds the first device to the network resulting in M=1 and the token counter of the first device is set to K−1. Thus S=K−1 and M+S=K as is required.

FIGS. 7 and 8 collectively depict a joining protocol relating to a device DJ attempting to join the network by being connected to existing member device DX, in accordance with embodiments of the present invention. FIG. 7 illustrates the network's joining protocol from the perspective of the member device DX, and FIG. 8 illustrates the network's joining protocol from the perspective of the joining member device DJ.

In FIG. 7, step 31 asks whether DX has at least one token. If NO, then the joining protocol aborts in step 32. If YES, then DX attempts in step 33 to authenticate DJ. If the authentication of DJ fails, then the joining protocol aborts in step 32. If the authentication of DJ succeeds, then the network data structure is transferred (i.e., copied) from DX to DJ in step 34, followed by decrementing the token counter of DX by 1 in step 35 to adjust for the entry of DJ into the network.

If DX has any remaining tokens after execution of step 35, then DX may distribute a portion of DX's remaining tokens to DJ as depicted in step 36. Alternatively, DX may not distribute any of DX's remaining tokens to DJ. Assume that prior to the attempted joining of DJ, the device DX has a token count CX. If CX=0, then the joining rule may bar DJ from joining the network through the connection between DJ and DX. Alternatively, if CX=0 and M>1 and if during execution of the joining protocol DX is directly or indirectly connected to another device DXX of the M devices (wherein DXX has a token count of at least 1), then upon the joining of DJ to the network, the joining rule may decrement the token count of DXX by 1 and set the token count of DJ to zero, which permits DJ to join the network through its connection with DX even though DX has no tokens. If CX=1, then DX loses its one token so that DJ can join the network. If CX>1, then a first joining rule may be such that DX retains all of its tokens except the one token necessary for DJ to join the network. If CX>1, then a second joining rule may be such that DX distributes a portion of DX's remaining tokens to DJ. For example, the second joining rule may state that DX distributes α tokens to DJ, wherein 0<α£CX−1, which would decrement the token count of DX by 1+α and setting the token count of DJ to α. A possible value of α is (CX−1)/2 rounded downward to the next lowest integer {if (CX−1)/2 is not an integer}, which represents an attempt to uniformly distnbutes DX's tokens between DX and DJ. Note that the first joining rule is equivalent to having α=0 when CX>1.

In FIG. 8, step 41 attempts to have DJ authenticate DX. If the authentication of DX fails, then the joining protocol aborts in step 42. If the authentication of DX succeeds, then DJ receives and stores the network data structure from DX in step 43. If DX has any remaining tokens after execution of step 43, then DJ may receive a portion of DX's remaining tokens in step 44 as discussed supra in conjunction with step 36 of FIG. 7. Alternatively, DJ may not receive any of DX's remaining tokens as discussed supra in conjunction with FIG. 7.

FIGS. 9 and 10 collectively depict a leaving protocol relating to a device DL attempting to leave the network by being connected to remaining member device DY, in accordance with embodiments of the present invention. FIG. 9 illustrates the network's leaving protocol from the perspective of the remaining member device DY, and FIG. 8 illustrates the network's leaving protocol from the perspective of the leaving member device DL.

In FIG. 9, step 51 attempts to have DY authenticate DL. If the authentication of DL fails, then the leaving protocol aborts in step 52. If the authentication of DL succeeds and DL has a token count of CL (i.e., CL tokens), then remaining member device DY receives the CL tokens of the leaving member device DL in step 53, followed by incrementing the token counter of DY by 1+CL in order to preserve the M+S=K network equation. Additional possibilities exist for distributing the CL tokens in the network if M>2 prior to the leaving of DL from the network. If DY is directly or indirectly connected to another J devices of the M devices while the leaving protocol is being executed, then the token counts of DY and of the other J devices may be incremented such that SJ+1 is incremented by 1+CL, wherein SJ+1 denotes a summation of the token counts over DY and the J devices. As a first example, the token count of DY and the token counts of J devices may be individually incremented such that the resultant total token counts of DY and the J devices are approximately uniformly distributed among DY and the J devices. As a second example, the token count of DY and the token counts of J devices may be individually incremented such that the 1+CL tokens are approximately uniformly distributed among DY and the J devices. As a third example, the token count of DY and the token counts of J devices may individually incremented such that the 1+CL tokens are randomly distributed among DY and the J devices in accordance with a probability distribution. The probability distribution may be uniform with respect to DY and the J devices. Alternatively, the probability distribution may be biased with respect to DY and the J devices such as by, inter alia, favoring DY or by favoring one or more selected devices of the J devices.

In FIG. 10 step 61 attempts to have DL authenticate DY. If the authentication of DY fails, then the leaving protocol aborts in step 62. If the authentication of DY succeeds and DL has a token count of CL (i.e., CL tokens), then the leaving member device DL may send its CL tokens to the remaining member device DY in step 63, or any of the additional possibilities discussed supra in connection with FIG. 9 may apply for distributing the CL tokens in the network. In step 64, DL destroys DL's copy of the network data structure. In step 65, DL destroys DL's copy of DL's stored content if DL has stored content.

None of the M devices are required to be connected to any other device of the M devices. When a given device of the M devices connects with another device of the M devices, then the given device and the another device must each execute a connection protocol verifying each other's authenticity. FIG. 11 depicts such a connection protocol relating to a device DC attempting to connect to the network by being connected to member device DZ of the network, in accordance with embodiments of the present invention. In FIG. 11, step 71, DZ attempts to authenticate DC, and DC attempts to authenticate DZ. If either of these authentication attempts fail, then the connection protocol aborts in step 6\72. If both of these authentication attempts succeed then, then data transfer from DZ to DC and/or from DC to DZ may occur in step 73, and such data transfer may proceed in a secure manner such as by being encrypted.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A network, comprising:
M devices such that M³1, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network;
network rules, comprising a joining rule for effectuating a non-network device DJ joining the network and a leaving rule for effectuating a device DL of the M devices leaving the network; and
the network not including a server device for managing the number of devices in the network.

2. The network of claim 1, said joining rule requiring DJ to be connected to a device DX of the M devices and while DJ is connected to the device DX a joining protocol must be executed by which DX authenticates DJ and by which DJ authenticates DX, and if said authentications are established through said joining protocol then DJ is joined to the network if S>0 and the joining protocol adjusts the token counts of the M devices such that S is decremented by 1 and the number of devices M of the network is incremented by 1 so that said equation is satisfied upon the joining of DJ to the network, wherein if each of said authentications are not established then DJ is not joined to the network through the connection between DJ and DX.

3. The network of claim 2, wherein prior to the attempt by DJ to join the network the device DX has a token count CX of at least 1, and wherein upon the joining of DJ to the network said decrementing S by 1 is effectuated by decrementing the token count of DX by 1+α and setting the token count of DJ to α, wherein α is a positive integer in the range of 0£α£CX−1.

4. The network of claim 3, wherein CX=1, and wherein α=0.

5. The network of claim 3, wherein CX>1, and wherein α=0.

6. The network of claim 3, wherein CX>1, and wherein α=(CX−1)/2 rounded downward to the next lowest integer if (CX−1)/2 is not an integer.

7. The network of claim 2, wherein prior to the attempted joining of DJ the device DX has a token count CX of zero which bars DJ from joining the network through the connection between DJ and DX.

8. The network of claim 2, wherein prior to the attempted joining of DJ the device DX has a token count CX of zero and M>1, wherein during execution of the joining protocol DX is directly or indirectly connected to another device DXX of the M devices, wherein DXX has a token count of at least 1, and wherein upon the joining of DJ to the network said decrementing S by 1 is effectuated by decrementing the token count of DXX by 1 and setting the token count of DJ to zero.

9. The network of claim 1, said leaving rule requiring DL to be connected to a device DY of the M devices and while DL is connected to the device DY a leaving protocol must be executed by which DY authenticates DL and by which DL authenticates DY, and if said authentications are established through said leaving protocol then DL is deleted from the network and the leaving protocol adjusts the token counts of the remaining M−1 devices such that S is incremented by 1+CL wherein CL is the token count of DL and the number of devices M of the network is decremented by 1 so that said equation is satisfied upon the leaving of DL from the network, wherein if each of said authentications are not established then DL is not permitted to leave the network through the connection between DL and DY.

10. The network of claim 9, wherein upon the leaving of DL from the network said incrementing S by 1 is effectuated by incrementing the token count of DY by 1+CL.

11. The network of claim 9, wherein M>2 prior to the leaving of DL from the network, wherein upon the leaving of DL from the network said incrementing S by 1 is effectuated by incrementing the token count of DY and the token counts of another J devices of the M devices to which DY is directly or indirectly connected such that SJ+1 is incremented by 1+CL, and wherein SJ+1 denotes a summation of the token counts over DY and the J devices.

12. The network of claim 11, wherein the token count of DY and the token counts of J devices are individually incremented such that the resultant total token counts of DY and the J devices are approximately uniformly distributed among DY and the J devices.

13. The network of claim 11, wherein the token count of DY and the token counts of J devices are individually incremented such that the 1+CL tokens are approximately uniformly distributed among DY and the J devices.

14. The network of claim 11, wherein the token count of DY and the token counts of J devices are individually incremented such that the 1+CL tokens are randomly distributed among DY and the J devices.

15. The network of claim 1, wherein the network rules comprise a token redistribution rule which prescribes at least one condition that triggers a redistribution of the S tokens among the M devices, and wherein the token redistribution rule further prescribes an algorithm for effectuating said redistribution, and wherein the algorithm takes into account the condition that triggered the redistribution.

16. The network of claim 1, wherein none of the M devices are required to be connected to any other device of the M devices, and when a given device of the M devices connects with another device of the M devices then the given device and the another device must each execute a connection protocol verifying each other's authenticity.

17. The network of claim 1, wherein each device of the M devices has a memory for storing capability flags which are unique to each device, and wherein the joining protocol and leaving protocol each take into account at least one of said capability flags.

18. The network of claim 1, wherein each device of the M devices has a memory for storing a same network data structure that comprises network information that is not unique to any device of the M devices.

19. The network of claim 16, wherein the network data structure comprises a revocation list of rogue devices, wherein the joining protocol does not permit DJ to be joined to the network if DJ is on the revocation list.

20. The network of claim 1, wherein the device DL must destroy any stored content upon leaving the network.

21. The network of claim 1, wherein if DJ is joined to the network then the joining protocol provides DJ with an decryption key and provides DJ with an encryption key if DJ has a real token counter but does not provide DJ with said encryption key if DJ has a virtual token counter.

22. A method of joining a non-network device DJ to a network of devices, comprising:
providing the network as comprising M devices such that M³1, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network, and wherein the network does not include a server device for managing the number of devices in the network; and
attempting to join the device DJ to the network in accordance with a joining rule.

23. The method of claim 22, said joining rule requiring DJ to be connected to a device DX of the M devices and while DJ is connected to the device DX a joining protocol must be executed by which DX authenticates DJ and by which DJ authenticates DX, and if said authentications are established through said joining protocol then DJ is joined to the network if S>0 and the joining protocol adjusts the token counts of the M devices such that S is decremented by 1 and the number of devices M of the network incremented by 1 so that said equation is satisfied upon the joining of DJ to the network, wherein if each of said authentications are not established then DJ is not joined to the network through the connection between DJ and DX.

24. The method of claim 23, wherein prior to said attempting DX has a token count CX of at least 1, and wherein upon the joining of DJ to the network said decrementing S by 1 is effectuated by decrementing the token count of DX by 1+α and setting the token count of DJ to α, wherein α is a positive integer in the range of 0£α£CX−1.

25. The method of claim 24, wherein CX=1, and wherein α=0.

26. The method of claim 24 wherein CX>1, and wherein α=0.

27. The method of claim 24, wherein CX>1, and wherein α=(CX−1)/2 rounded downward to the next lowest integer if (CX−1)/2 is not an integer.

28. The method of claim 23, wherein prior to said attempting DX has a token count CX of zero which bars DJ from joining the network through the connection between DJ and DX.

29. The method of claim 23, wherein prior to said attempting DX has a token count CX of zero and M>1, wherein during execution of the joining protocol DX is directly or indirectly connected to another device DXX of the M devices, wherein DXX has a token count of at least 1, and wherein upon the joining of DJ to the network said decrementing S by 1 is effectuated by decrementing the token count of DXX by 1 and setting the token count of DJ to zero.

30. The method of claim 22, wherein each device of the M devices has a memory for storing capability flags which are unique to each device, and wherein the joining protocol takes into account at least one of said capability flags.

31. The method of claim 22, wherein each device of the M devices has a memory for storing a same network data structure that comprises network information that is not unique to any device of the M devices.

32. The method of claim 31, wherein the network data structure comprises a revocation list of rogue devices, wherein the joining protocol does not permit DJ to be joined to the network if DJ is on the revocation list.

33. The method of claim 22, wherein if DJ is joined to the network then the joining protocol provides DJ with an decryption key and provides DJ with an encryption key if DJ has a real token counter but does not provide DJ with said encryption key if DJ has a virtual token counter.

34. A method by which a device DL leaves a network, comprising:
providing the network as comprising M devices such that M³1, device DL being one of the M devices, each device of the M devices having a real or virtual token counter that stores a token count of not less than zero, wherein an equation M+S=K must be satisfied, wherein M is a variable that changes when devices join or leave the network, wherein S denotes the number of tokens in the network and is numerically equal to a summation of the token counts over the M devices, wherein K is a characteristic constant of the network having an integer value of at least 2 that is established upon creation of the network, and wherein the network does not include a server device for managing the number of devices in the network; and
attempting by the device DL to leave the network in accordance with a leaving rule.

35. The method of claim 34, said leaving rule requiring DL to be connected a device DY of the M devices and while DL is connected to the device DY a leaving protocol must be executed by which DY authenticates DL and by which DL authenticates DY, and if said authentications are established through said leaving protocol then DL is properly deleted from the network and the leaving protocol adjusts the token counts of the remaining M−1 devices such that S is incremented by 1+CL wherein CL is the token count of DL, and the number of devices M of the network is decremented by 1 so that said equation is satisfied upon the leaving of DL from the network, wherein if each of said authentications are not established then DL is not permitted to leave the network through the connection between DL and DY.

36. The method of claim 35, wherein upon the leaving of DL from the network said incrementing S by 1 is effectuated by incrementing the token count of DY by 1+CL.

37. The method of claim 35, wherein M>2 prior to the leaving of DL from the network, wherein upon the leaving of DL from the network said incrementing S by 1 is effectuated by incrementing the token count of DY and the token counts of another J devices of the M devices to which DY is directly or indirectly connected such that SJ+1 is incremented by 1+CL, and wherein SJ+1 denotes a summation of the token counts over DY and the J devices.

38. The method of claim 37, wherein the token count of DY and the token counts of J devices are individually incremented such that the resultant total token counts of DY and the J devices are approximately uniformly distributed among DY and the J devices.

39. The method of claim 37, wherein the token count of DY and the token counts of J devices are individually incremented such that the 1+CL tokens are approximately uniformly distributed among DY and the J devices.

40. The method of claim 37, wherein the token count of DY and the token counts of J devices are individually incremented such that the 1+CL tokens are randomly distributed among DY and the J devices.

41. The method of claim 34, wherein each device of the M devices has a memory for storing a same network data structure that comprises network information that is not unique to any device of the M devices.

42. The method of claim 34, wherein the device DL must destroy any stored content upon leaving the network.
